(19) United States
(12) Patent Application Publication
(10) Pub. No.: US 2013/0212029 A1
(43) Pub. Date: Aug. 15, 2013

(54) Product Packaging Profiler

(71) Applicant: Kevin C. Krejci, San Francisco, CA (US)

(72) Inventor: Kevin C. Krejci, San Francisco, CA (US)

(73) Assignee: FUJITSU LIMITED, Kanagawa (JP)

(21) Appl. No.: 13/372,215

(22) Filed: Feb. 13, 2012

(51) Int. Cl. G06Q 10/00

(52) U.S. Cl. 705/308

(57) ABSTRACT

In accordance with some embodiments of the present disclosure, a method may include receiving product packaging information from a user. The method may also include determining user information associated with the user. The method may further include making a recommendation regarding disposal of the product packaging based at least on the product packaging information and the user information.

### TECHNICAL FIELD

The present disclosure generally relates to systems and methods for identifying and profiling product packaging for desirable disposal and other purposes.

### BACKGROUND

Product packaging if a source of tremendous resource waste and generally has a negative impact on the environment and human health. Often, consumers desire to reduce waste through their purchase decisions, but it may be difficult to compare various packaging designs, evaluate their environmental impact, and/or make optimal decisions when purchasing products and/or disposing of packaging.

### SUMMARY

In accordance with some embodiments of the present disclosure, a method may include receiving product packaging information from a user. The method may also include determining user information associated with the user. The method may further include making a recommendation regarding disposal of the product packaging based at least on the product packaging information and the user information.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates a block diagram of an example network environment, in accordance with embodiments of the present disclosure;

FIG. 2 illustrates a block diagram of an example client host environment, in accordance with embodiments of the present disclosure;

FIG. 3 illustrates a flow chart depicting operation of a product packaging profiler application, in accordance with embodiments of the present disclosure;

FIG. 4 illustrates a flow chart depicting a method of operation for a product packaging profiler application, in accordance with embodiments of the present disclosure; and

FIG. 5 illustrates a block diagram of an example computing system architecture that may be used to implement one or more of physical servers or client nodes depicted in FIG. 1, in accordance with embodiments of the present disclosure.

### DETAILED DESCRIPTION

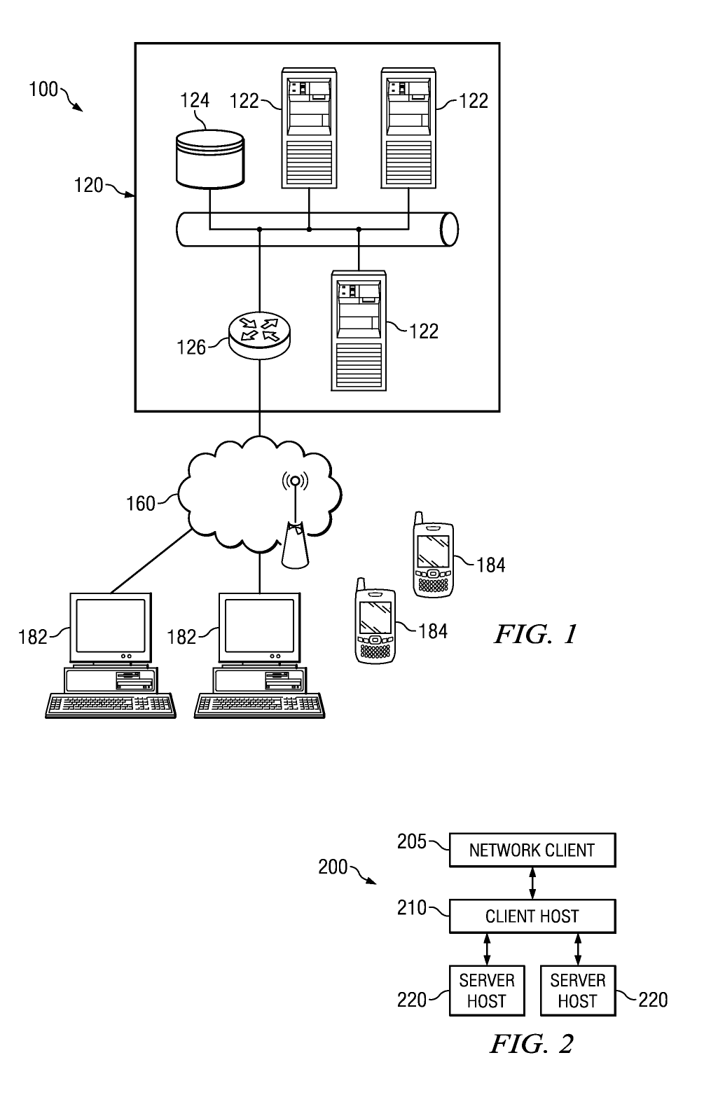

FIG. 1 illustrates a block diagram of an example network environment 100, in accordance with embodiments of the present disclosure. Particular implementations of the disclosure may operate in a wide area network environment, such as the Internet, including multiple network addressable systems. Network cloud 160 generally represents one or more interconnected networks, over which the systems and hosts described herein may communicate. Network cloud 160 may include packet-based wide area networks (such as the Internet), private networks, wireless networks, satellite networks, cellular networks, paging networks, and the like.

As FIG. 1 illustrates, implementations of the disclosure may operate in a network environment comprising a network application hosting site 120, such as an informational web site, social network site, and/or other suitable site. Although FIG. 1 illustrates only one network application hosting site 120, implementations of the disclosure may operate in network environments that include multiples of one or more of the individual systems and sites disclosed herein. Client nodes 182, 184 may be operably coupled to the network environment via a network service provider or any other suitable means.

Network application hosting site 120 may be a network addressable system that hosts a network application (e.g., product packaging profiler network application 302 described in greater detail below) accessible to one or more users over a computer network. The network application may be an informational web site where users request and receive identified web pages and other content over the computer network. The network application may also be a search platform, an on-line forum or blogging application where users may submit or otherwise configure content for display to other users. The network application may also be a social network application allowing users to configure and maintain personal web pages. The network application may also be a content distribution application that displays available content, and transmits content to users.

Network application hosting site 120 may comprise one or more physical servers 122 and a content data store 124. The one or more physical servers 122 may be operably coupled to network 160 via a router 126. The one or more physical servers 122 may host functionality that provides a network application (e.g., product packaging profiler network application 302) to a user. The functionality hosted by the one or more physical servers 122 may include web or HTTP servers, ad serving systems, geo-targeting systems, and the like. Still further, some or all of the functionality described herein may be accessible using an HTTP interface or presented as a web service using SOAP or other suitable protocols.

Content data store 124 may store content as digital content data objects. A content data object or content object may comprise an individual item of digital information typically stored or embodied in a data file or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, etc. Structurally, content data store 124 connotes a large class of data storage and management systems. In particular implementations, content data store 124 may be implemented by any suitable physical system including components, such as database servers, mass storage media, media library systems, and the like.

Network application hosting site 120 may provide web pages that include an information package or module describing one or more attributes of a network addressable resource, such as a web page containing an article or product description, a downloadable or streaming media file, and the like. The web page may also include one or more ads, such as banner ads, text-based ads, sponsored videos, games, and the like. Generally, web pages and other resources include hypertext links or other controls that a user can activate to retrieve additional web pages or resources. A user “clicks” on the hyperlink with a computer input device to initiate a retrieval request to retrieve the information associated with the hyperlink or control.

FIG. 2 illustrates a block diagram of an example client host environment, in accordance with embodiments of the present disclosure. As FIG. 2 illustrates, network application hosting site 120 may comprise one or more network clients 205 and one or more client hosts 210 operating in conjunction with one or more server hosts 220. The foregoing functional modules may be realized by hardware, executable modules stored on a computer readable medium, or a combination of both. The functional modules, for example, may be hosted on one or more physical servers 122 and/or one or more client nodes 182, 184.

Network client 205 may comprise a web client hosted on client nodes 182, 184, a client host 210 located on physical server 122, or a server host 220 located on physical server 122. Client host 210 may be an executable web or HTTP server module that accepts HyperText Transport Protocol (HTTP) requests from network clients 205 acting as a web clients, such web browser client applications hosted on client nodes 182, 184, and serving HTTP responses including contents, such as HyperText Markup Language (HTML) documents and linked objects (images, advertisements, etc.). Client host 210 may also be an executable module that accepts Simple Object Access Protocol (SOAP) requests from one or more client hosts 210 or one or more server hosts 220. In some embodiments, client host 210 may have the capability of delegating all or part of single or multiple requests from network client 205 to one or more server hosts 220. Client host 210, as discussed above, may operate to deliver a network application (e.g., product packaging profiler network application 302).

In particular embodiments, client host 210 may act as a server host 220 to another client host 210 and may function to further delegate requests to one or more server hosts 220 and/or one or more client hosts 210. Server hosts 220 may host one or more server applications, such as an ad selection server, sponsored search server, content customization server, and/or other applications

A client node may comprise a computer or computing device including functionality for communicating over a computer network. For example, a client node may comprise a computer 182 (e.g., desktop computer, laptop computer, notebook computer, tablet computer), a mobile device 184 (e.g., smart phone, personal digital assistant, satellite navigation device, portable media player, portable game console), kiosk computer, point-of-sale device, and/or any other suitable device and may vary in size, shape, performance, functionality, and price. A client node may execute one or more client applications (e.g., product packaging profiler network application 302), such as a web browser and/or a dedicated application, to access and view content over a computer network. In some implementations, client applications may allow users to enter addresses of specific network resources to be retrieved. These addresses can be Uniform Resource Locators, or URLs. In addition, once a page or other resource has been retrieved, the client applications may provide access to other pages or records when the user “clicks” on hyperlinks to other resources. In some implementations, such hyperlinks are located within web pages and provide an automated way for the user to enter the URL of another page and to retrieve that page. The pages or resources can be data records including as content plain textual information, or more complex digitally encoded multimedia content, such as software programs or other code objects, graphics, images, audio signals, videos, and so forth. In other embodiments, client applications may be dedicated-purpose applications configured to retrieve specified pages or other resources specific to the applications with little or no input from the user.

The networked systems described herein may communicate over network 160 using any suitable communications protocols. For example, client nodes 182 and 184, as well as various servers of the systems described herein, may include Transport Control Protocol/Internet Protocol (TCP/IP) networking stacks to provide for datagram and transport functions. Of course, any other suitable network and transport layer protocols can be utilized.

In addition, hosts or end-systems described herein may use a variety of higher layer communications protocols, including client-server (or request-response) protocols, such as the HyperText Transfer Protocol (HTTP) and other communications protocols, such as HTTP-S, FTP, SNMP, TELNET, and a number of other protocols, may be used. In addition, a server in one interaction context may be a client in another interaction context. Still further, in particular implementations, the information transmitted between hosts may be formatted as HyperText Markup Language (HTML) documents. Other structured document languages or formats may be used, such as XML, and the like.

In some client-server protocols, such as the use of HTML over HTTP, a server generally transmits a response to a request from a client. The response may comprise one or more data objects. For example, the response may comprise a first data object, followed by subsequently transmitted data objects. In one implementation, for example, a client request may cause a server to respond with a first data object, such as an HTML page, which itself refers to other data objects. A client application, such as a browser, will request these additional data objects as it parses or otherwise processes the first data object.

Mobile client nodes 184 may use other communications protocols and data formats in lieu of or in addition to those described above. For example, mobile client nodes 184, in some embodiments, may include Wireless Application Protocol (WAP) functionality and a WAP browser. The use of other wireless or mobile device protocol suites are also possible, such as NTT DoCoMo's i-mode wireless network service protocol suites. In addition, the network environment may also include protocol translation gateways, proxies or other systems to allow mobile client nodes 184, for example, to access other network protocol environments. For example, a user may use a mobile client node 184 to capture an image and upload the image over the carrier network to a content site coupled to the Internet.

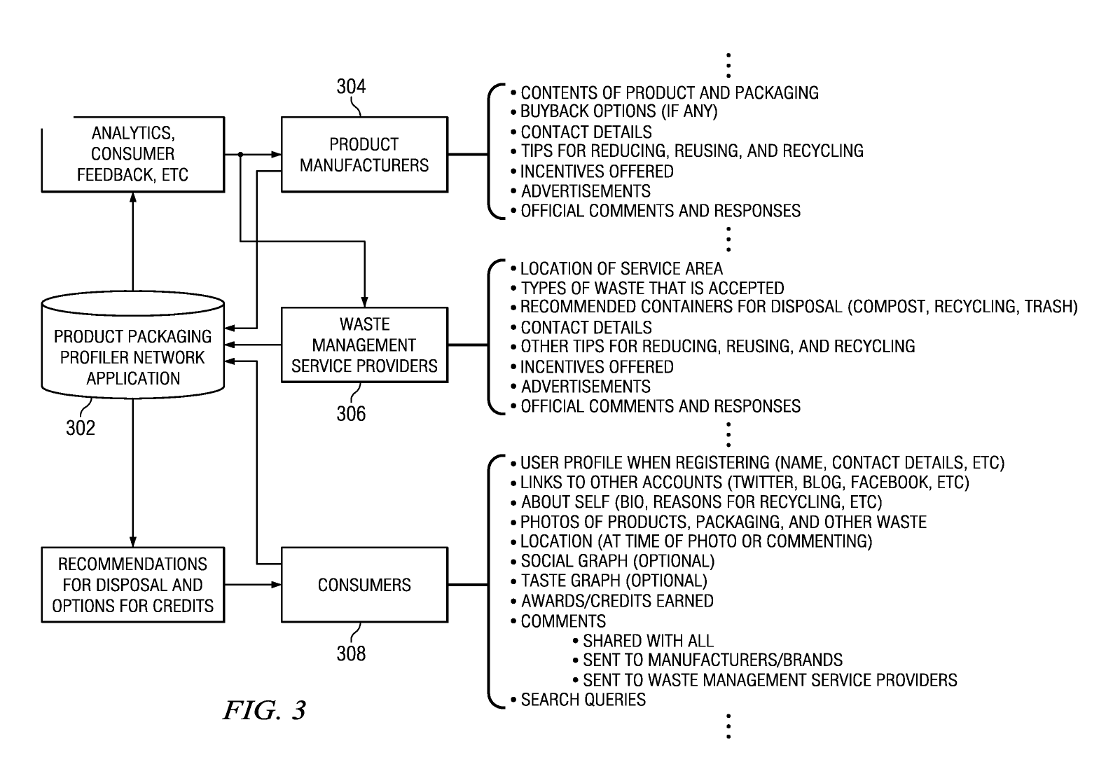

FIG. 3 illustrates a flow chart depicting operation of a product packaging profiler network application 302, in accordance with embodiments of the present disclosure. As shown in FIG. 3, product packaging profiler network application 302 may receive from and communicate to product manufacturers 304, waste management service providers 306, and consumers 308 information regarding products and product packaging associated with such products. Product packaging profiler network application may be implemented using system 100, system 200, and/or various components thereof.

In operation, as shown in FIG. 3, product packaging profiler network application 302 may receive information from one or more product manufacturers 304. Such a product manufacturer 304 may interface with product packaging profiler network application 302 using a client node 182, 184, as described above. Information received from a product manufacturer 304 may include, without limitation, contents of products manufactured by the product manufacturer and their associated packaging; manufacturer buyback programs or options for product packaging; contact information; information for reducing, reusing, or recycling product packaging; incentives offered to customers for desirable disposal of product packaging; product advertisements; official comments and responses to consumer comments or questions; and/or other information.

In addition, product packaging profiler network application 302 may receive information from one or more waste management service providers 306. Such a waste management service provider 306 may interface with product packaging profiler network application 302 using a client node 182, 184, as described above. Information received from a waste management service provider 306 may include, without limitation, one or more locations of service areas; types of wastes accepted; recommended containers for disposal (e.g, compost, recycling, trash); contact information; information for reducing, reusing, or recycling product packaging; incentives offered to customers for desirable disposal of product packaging; advertisements; official comments and responses to consumer comments or questions; and/or other information.

Furthermore, product packaging profiler network application 302 may receive information from one or more consumers 308. Such a consumer 308 may interface with product packaging profiler network application 302 using a client node 182, 184, as described above. Information received from a consumer 308 may include, without limitation, a user profile (e.g., name, contact information, etc.); links to other user websites or social networking profiles (e.g., a blog, Twitter, Facebook, etc.); information regarding the user (e.g., a biography, reasons for recycling, etc.); photos of products; location of consumer 308 (e.g. at time photo was taken and/or at time that consumer 308 entered comment), product packaging, and/or other waste; search queries; product packaging barcode scans; social networking social graphs and/or taste graphs; awards and/or credits earned for submitting information via product packaging profiler network application 302; comments; and/or other information.

As discussed above, product packaging profiler network application 302 may also communicate information to product manufacturers 304, waste management services providers 306, and/or consumers 308. For example, product packaging profiler network application 302 analyze information provided by consumers 308 to provide analytics to product manufacturers 304 and/or waste management service providers 306. As another example, consumer comments and feedback communicated by consumers 308 to product packaging profiler network application 302 may also be communicated to product manufacturers and/or waste management service providers 306. As a further example, product packaging profiler network application 302 may, in response to a consumer 308 providing a scanned barcode, photograph, or a search query regarding a particular product or its packaging, may communicate recommendations for disposal of such packaging. As an additional example, product packaging profiler network application 302 may communicate options to a consumer 308 for applying credits or awards earned by a consumer 308 for interacting with product packaging profiler network application 302.

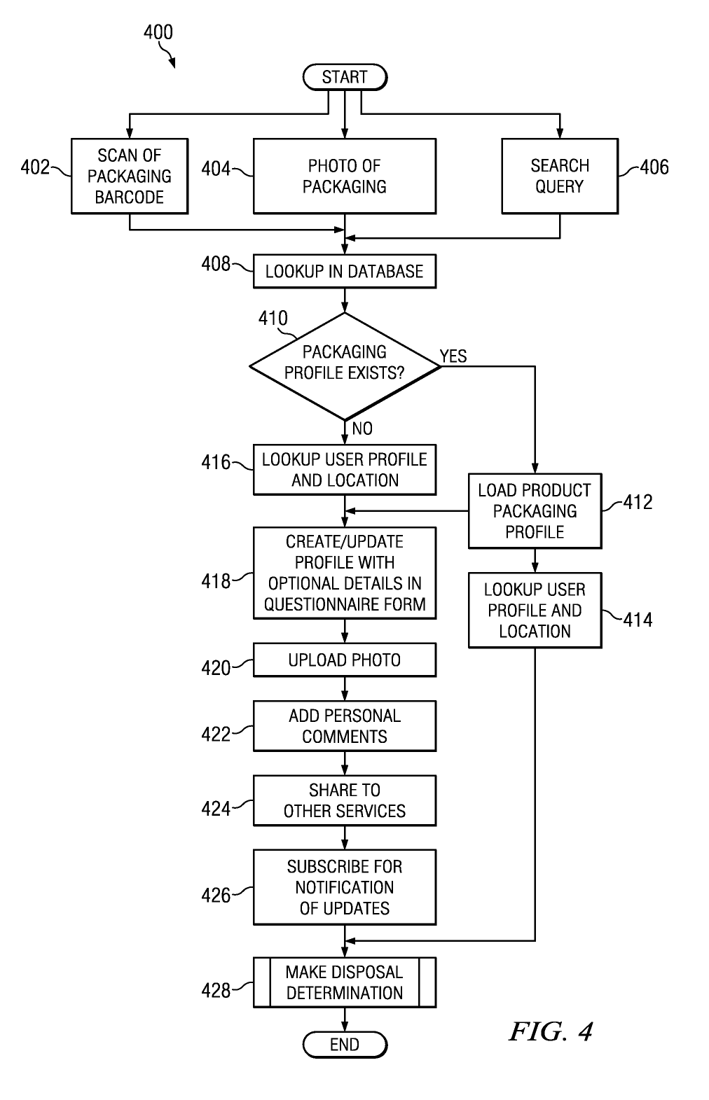

FIG. 4 illustrates a flow chart depicting a method 400 of operation for a product packaging profiler application, in accordance with embodiments of the present disclosure. Method 400 may be performed at least in part by system 100, system 200, and/or any other suitable system. According to one embodiment, method 400 may comprise operations 402-428. As noted above, teachings of the present disclosure may be implemented in a variety of configurations of system 100 and/or system 200. As such, the preferred initialization point for method 400 and the order of the operations 402-428 comprising method 200 may depend on the implementation chosen.

Method 400 may begin at any of operations 402, 404, and/or 406. At operation 402, a consumer (e.g, using client-side portion of product packaging profiler network application 302 on a mobile device 184) may scan a barcode, QR code, or other unique identifier on the packaging of a product. After completion of operation 402, method 400 may proceed to operation 408.

At operation 404, a consumer (e.g., using client-side portion of product packaging profiler network application 302 camera-enabled mobile device 184) may take a photograph of a product or its associated packaging and communicate (e.g., upload) the photograph to the product packaging profiler network application. In some embodiments, either of the product packaging profiler network application and/or a third-party image processing service may use suitable analysis techniques to identify the product based on the photograph. After completion of operation 404, method 400 may proceed to operation 408.

At operation 406, a consumer (e.g, using client-side portion of product packaging profiler network application 302 on a client node 182, 184) may enter search terms relating to a product or its packaging (e.g., a name of a product, a description of the product or its packaging, etc.). After completion of operation 406, method 400 may proceed to operation 408.

At operation 408, the product packaging profiler network application (e.g., server-side portion of product packaging profiler network application executing on network application hosting site 120) may search a database or other suitable data structure (e.g., stored on content data store 124) for a profile associated with the product packaging associated with the scan taken at operation 402, the photograph taken at operation 404, or the search query entered at operation 406.

At operation 410, the product packaging profiler network application (e.g., server-side portion of product packaging profiler network application executing on network application hosting site 120) may determine whether a profile exists for product packaging for the data entered at either of operations 402, 404, or 406. If no profile exists, method 400 may proceed to operation 416. Otherwise, if a profile exists, method 400 may proceed to operation 412.

At operation 412, in response to a determination that a profile exists for product packaging associated with a scan, photograph, or search query, the product packaging profiler network application may load (e.g., front content data store 124), a profile associated with the product packaging.

At operation 414, the product packaging profiler network application may determine the user profile associated with the consumer (e.g., based on login information or other credentials of the consumer) and/or a location of such user (e.g., based on login information or other credentials of the consumer, global positioning system data associated with a mobile device 184 of the consumer, and/or data associated with other positioning systems capable of determining mobile device 184 location). After completion of operation 414, method 400 may proceed to either of operation 418 or operation 428.

At operation 416, in response to a determination that a profile does not exist for product packaging associated with a scan, photograph, or search query, the product packaging profiler network application may determine the user profile associated with the consumer (e.g., based on login information or other credentials of the consumer) and/or a location of such user (e.g., based on login information or other credentials of the consumer, global positioning system data associated with a mobile device 184 of the consumer, and/or data associated with other positioning systems capable of determining mobile device 184 location).

At operation 418, the consumer may enter information regarding the product packaging (e.g., into a questionnaire form provided by product packaging profiler network application 302) and the product packaging profiler network application may update or create a profile for the product packaging based on such information and/or information provided at operations 402, 404, and/or 406. At operation 420, the consumer may upload one or more additional photos associated with the product and/or product packaging that may be added to the profile for the product packaging. At operation 422, the consumer may provide personal comments regarding the product packaging, which may also be added to the profile for the product packaging. Thus, once a profile is created for packaging, various users may curate, comment, rate, and/or post additional media regarding the packaging. Targeting advertising and sales may also be displayed in connection with product packaging profiles. Additionally, analytics and data mining of data provided to product packaging profiler network application may enable reporting and services functionality that may be sold to vendors to inform them regarding consumer sentiment, and encourage them to improve packaging decisions, possibly encouraging vendors to improve their packaging designs to be more environmentally responsible and health conscious.

At operation 424, information provided by the consumer regarding the product packaging and/or information from the profile for the product packaging may be shared to other services (e.g., social networks) based on information in the consumer's profile relating to social networks.

At operation 426, the consumer may indicate to the product packaging profiler network application a desire to subscribe for notification of any updates to the profile for the product packaging. If the consumer provides such indication, the product packaging profiler network application may from time to time communicate updates associated with the profile for the product packaging to the consumer. After completion of operation 426, method 400 may proceed to operation 428.

At operation 428, based on information provided by a consumer associated with product packaging (e.g., scan, photograph, or search query), the location of the consumer, information regarding product packaging provided by a waste management service provider, and/or information regarding product packaging provided by a product manufacturer, the product packaging profiler network application may determine a recommended method of disposal of the product packaging and communication such recommended method to the consumer. For example, contextual data such as a user profile, address, location of photo or scan, and product packaging details may be matched to a database of existing disposal options or services in proximity to the consumer in order to determine an optimal method of disposal. As a specific example, a person inquiring about packaging while in their home may be advised to dispose of the packaging in an appropriate container supplied by their waste management provider (e.g., recycle bin, trash, compost, etc.). As another specific example, if the packaging is considered toxic or hazardous, the consumer may be referred to an appropriate local business or public organization that may handle the packaging appropriately. As a further specific example, if a consumer is at a public location (e.g., school, shopping mall, park, or campground), disposal options could be presented to the consumer based on location. After completion of operation 428, method 400 may end.

Although FIG. 4 discloses a particular number of operations to be taken with respect to method 400, method 400 may be executed with greater or lesser operations than those depicted in FIG. 4. In addition, although FIG. 4 discloses a certain order of operations to be taken with respect to method 400, the operations comprising method 400 may be completed in any suitable order.

Method 400 may be implemented using system 100, system 200, and/or any other system, device, or apparatus operable to implement method 200. In certain embodiments, method 400 may be implemented partially or fully in software and/or firmware embodied in computer-readable media.

In some embodiments, method 400 may be supplemented with a rewards system to encourage consumers to participate and upload content or to encourage viral “word-of-mouth sharing (e.g., via social networking sites).

While the foregoing systems and methods can be implemented by a wide variety of physical systems and in a wide variety of network environments, the client and server host systems described below provide example computing architectures for didactic, rather than limiting, purposes.

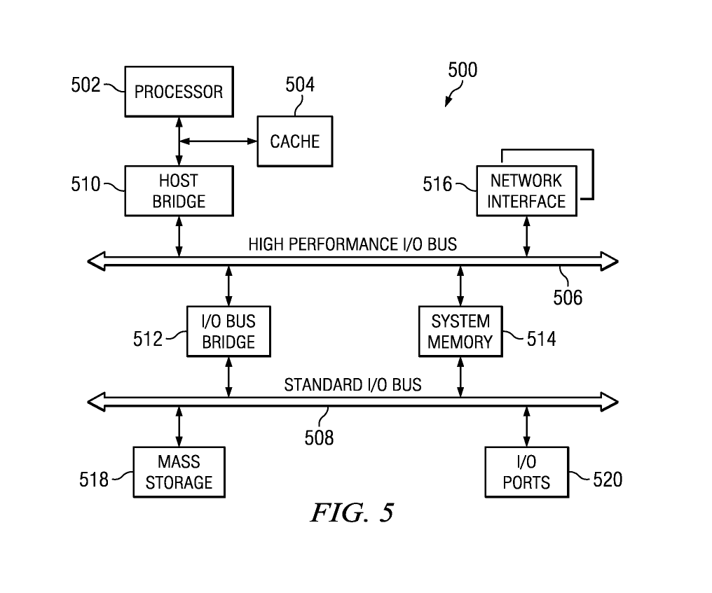

FIG. 5 illustrates a block diagram of an example computing system architecture that may be used to implement one or more of physical servers or client nodes depicted in FIG. 1, in accordance with embodiments of the present disclosure. In one embodiment, hardware system 500 may comprise a processor 502, a cache memory 504, and one or more software applications and drivers directed to the functions described herein. Additionally, hardware system 500 may include a high performance input/output (I/O) bus 506 and a standard I/O bus 508. A host bridge 510 may couple processor 502 to high performance I/O bus 506, whereas I/O bus bridge 512 may couple the two buses 506 and 508 to each other. A system memory 514 and a network/communication interface 516 couple to bus 506. Hardware system 500 may further include video memory (not shown) and a display device coupled to the video memory. Mass storage 518 and/or I/O ports 520 may couple to bus 508. Hardware system 500 may include a keyboard and pointing device, and a display device (not shown) coupled to bus 508. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 500 are described in greater detail below. In particular, network interface 516 may provide communication between hardware system 500 and any of a wide range of networks, such as an Ethernet (e.g., IEEE 802.3) network, etc. Mass storage 518 may provide permanent storage for the data and programming instructions to perform the above described functions implemented in server 122, whereas system memory 214 (e.g., DRAM) may provide temporary storage for the data and programming instructions when executed by processor 502. I/O ports 520 may include one or more serial and/or parallel communication ports that provide communication between additional peripheral devices, which may be coupled to hardware system 500.

Hardware system 500 may include a variety of system architectures; and various components of hardware system 500 may be rearranged. For example, cache 504 may be on-chip with processor 502. Alternatively, cache 504 and processor 502 may be packed together as a “processor module,” with processor 502 being referred to as the “processor core.” Furthermore, certain embodiments of the present disclosure may not require nor include all of the above components. For example, the peripheral devices shown coupled to standard I/O bus 508 may couple to high performance I/O bus 506. In addition, in some embodiments only a single bus may exist, with the components of hardware system 500 being coupled to the single bus. Furthermore, hardware system 500 may include additional components, such as additional processors, storage devices, or memories.

As discussed below, in one implementation, the operations of one or more of the physical servers described herein are implemented as a series of software routines run by hardware system 500. These software routines comprise a plurality or series of instructions to be executed by a processor in a hardware system, such as processor 502, for example. Initially, the series of instructions may be stored on a storage device, such as mass storage 518, for example. However, the series of instructions can be stored on any suitable storage medium, such as a diskette, CD-ROM, ROM, EEPROM, etc. Furthermore, the series of instructions need not be stored locally, and could be received from a remote storage device, such as a server on a network, via network/communication interface 516. The instructions may be copied from the storage device, such as mass storage 518, into memory 514 and then accessed and executed by processor 502.

An operating system may manage and control the operation of hardware system 500, including the input and output of data to and from software applications (not shown). The operating system provides an interface between the software applications being executed on the system and the hardware components of the system. According to one embodiment of the present disclosure, the operating system is the Windows® 95/98/NT/XP operating system, available from Microsoft Corporation of Redmond, Wash. However, the present disclosure may be used with other suitable operating systems, such as the Apple Macintosh Operating System, available from Apple Computer Inc. of Cupertino, Calif., UNIX operating systems, LINUX operating systems, ANDROID operation systems, and the like. Of course, other implementations are possible. For example, the server functionalities described herein may be implemented by a plurality of server blades communicating over a backplane.

Furthermore, the above-described elements and operations may be comprised of instructions that are stored on storage media. The instructions can be retrieved and executed by a processing system. Some examples of instructions are software, program code, and firmware. Some examples of storage media are memory devices, tape, disks, integrated circuits, and servers. The instructions are operational when executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

The present disclosure has been explained with reference to specific embodiments. For example, while embodiments of the present disclosure have been described as operating in connection with HTML and HTTP, the present disclosure can be used in connection with any suitable protocol environment. Furthermore, implementations of the disclosure can be used in systems directed to serving geo-targeted content other than ads to users. Other embodiments will be evident to those of ordinary skill in the art. It is therefore not intended that the present disclosure be limited, except as indicated by the appended claims.

All examples and conditional language recited herein are intended for pedagogical objects aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could me made hereto without departing from the spirit and scope of the invention.

What is claimed is:

1. A method comprising:
receiving product packaging information from a user;
determining user information associated with the user; and
making a recommendation regarding disposal of the product packaging based at least on the product packaging information and the user information.

2. The method of claim 1, wherein the information regarding the product packaging comprises any one of a scan of a barcode associated with the product packaging, a photograph associated with the product packaging, and a search query associated with the product packaging.

3. The method of claim 1, further comprising:
determining if a product packaging profile associated with the product packaging information exists; and
making the recommendation based on profile information of the product packaging profile.

4. The method of claim 1, wherein the product packaging profile comprises information received from a waste management service provider, and wherein making the recommendation comprises making a recommendation based on the information received from the waste management service provider.

5. The method of claim 1, wherein the product packaging profile comprises information received from a manufacturer of a product associated with the product packaging, and wherein making the recommendation comprises making a recommendation based on the information received from the manufacturer.

6. The method of claim 1, wherein making the recommendation comprises making the recommendation based on a physical location of the user.

7. The method of claim 1, further comprising:
receiving content from the user regarding the product packaging; and
adding the content to a product packaging profile associated with the product packaging, such that the content is accessible to any one of another user, a waste management service provider, and a manufacturer of a product associated with the product packaging.

8. An apparatus, comprising:
one or more processors;
computer-executable instructions carried on a computer readable medium, the instructions readable by the one or more processors, the instructions, when read and executed, cause the one or more processors to:
receive product packaging information from a user;
determine user information associated with the user; and
make a recommendation regarding disposal of the product packaging based at least on the product packaging information and the user information.

9. The apparatus of claim 8, wherein the information regarding the product packaging comprises any one of a scan of a barcode associated with the product packaging, a photograph associated with the product packaging, and a search query associated with the product packaging.

10. The apparatus of claim 8, wherein the instructions further cause the one or more processors to:
determine if a product packaging profile associated with the product packaging information exists; and
make the recommendation based on profile information of the product packaging profile.

11. The apparatus of claim 8, wherein the product packaging profile comprises information received from a waste management service provider, and wherein making the recommendation comprises making a recommendation based on the information received from the waste management service provider.

12. The apparatus of claim 8, wherein the product packaging profile comprises information received from a manufacturer of a product associated with the product packaging, and wherein making the recommendation comprises making a recommendation based on the information received from the manufacturer.

13. The apparatus of claim 8, wherein making the recommendation comprises making the recommendation based on a physical location of the user.

14. The apparatus of claim 8, wherein the instructions further cause the one or more processors to:
receive content from the user regarding the product packaging; and
add the content to a product packaging profile associated with the product packaging, such that the content is accessible to any one of another user, a waste management service provider, and a manufacturer of a product associated with the product packaging.

15. An article of manufacture comprising:
a computer readable medium; and
computer-executable instructions carried on the computer readable medium, the instructions readable by a processor, the instructions, when read and executed, for causing the processor to:
receive product packaging information from a user;
determine user information associated with the user; and
make a recommendation regarding disposal of the product packaging based at least on the product packaging information and the user information.

16. The article of manufacture of claim 15, wherein the information regarding the product packaging comprises any one of a scan of a barcode associated with the product packaging, a photograph associated with the product packaging, and a search query associated with the product packaging.

17. The article of manufacture of claim 15, wherein the instructions further cause the one or more processors to:
determine if a product packaging profile associated with the product packaging information exists; and
make the recommendation based on profile information of the product packaging profile.

18. The article of manufacture of claim 15, wherein the product packaging profile comprises information received from a waste management service provider, and wherein making the recommendation comprises making a recommendation based on the information received from the waste management service provider.

19. The article of manufacture of claim 15, wherein the product packaging profile comprises information received from a manufacturer of a product associated with the product packaging, and wherein making the recommendation comprises making a recommendation based on the information received from the manufacturer.

20. The article of manufacture of claim 15, wherein making the recommendation comprises making the recommendation based on a physical location of the user.

21. The article of manufacture of claim 15, wherein the instructions for further cause the one or more processors to:
receive content from the user regarding the product packaging; and
add the content to a product packaging profile associated with the product packaging, such that the content is accessible to any of another user, a waste management service provider, and a manufacturer of a product associated with the product packaging.
